(19) United States
(12) Patent Application Publication
(10) Pub. No.: US 2012/0170807 A1
(43) Pub. Date: Jul. 5, 2012

(54) APPARATUS AND METHOD FOR EXTRACTING DIRECTION INFORMATION IMAGE IN A PORTABLE TERMINAL

(75) Inventors: Chi-Hyeon PAEK, Gyeongsangbuk-do (KR); Dae-Beom PARK, Gyeongsangbuk-do (KR); Ung-Sik CHOI, Gyeongsangbuk-do (KR)

(73) Assignee: Samsung Electronics Co., LTD., Gyeonggi-Do (KR)

(21) Appl. No.: 13/338,643

(22) Filed: Dec. 28, 2011

(30) Foreign Application Priority Data
Jan. 3, 2011 (KR) 10-2011-0000308

(51) Int. Cl. G06K 9/00

(52) U.S. Cl. 382/103

(57) ABSTRACT

Provided is an apparatus and method for extracting a direction of an image in a portable terminal without using a sensor for extracting direction information of a captured image. An apparatus for extracting direction information of an image in a portable terminal includes a camera unit and a control unit, wherein the control unit extracts a detection direction of an object from the captured image as direction information, and stores the captured image together with the extracted direction information for a subsequent display of the captured image in a normal direction.

### CLAIM OF PRIORITY

This application claims the benefit under 35 U.S.C. §119(a) of a Korean Patent Application filed in the Korean Intellectual Property Office on Jan. 3, 2011 and assigned Serial No. 10-2011-0000308, the entire disclosure of which is hereby incorporated by reference.

### BACKGROUND OF THE INVENTION

1. Field of the Invention

The present invention relates generally to an apparatus and method for extracting direction information of an image in a portable terminal, and more particularly, to an apparatus and method for extracting direction information of a captured image in a portable terminal without using a sensor for a subsequent display.

2. Description of the Related Art

Recently, portable terminals have evolved to provide a high-rate data communication function as well as a voice communication function. The IMT-2000 mobile communication network is such a network which performs data communication that include packet data and video data.

The portable terminal is typically equipped with a camera or a TV receiver to provide a video signal display function. The portable terminal with a camera can capture/display moving pictures and still pictures and can transmit the captured pictures. The portable terminal with a TV receiver can display received image signals.

However, captured images are stored in the portable terminal according to the photograph directions of the portable terminal. Therefore, when viewing the captured images by an image viewer, the stored images are displayed in different orientations.

In order to solve the above problem, the portable terminal has a gravity sensor and stores an image together with the current direction information of the portable terminal extracted by the gravity sensor. Thus, when viewed sequentially by the image viewer, all of the stored images are displayed in the normal direction.

However, the portable terminal must be equipped with a gravity sensor in order to view all of the stored images in the normal direction. The additional sensor in turn increases the manufacturing cost of the portable terminal. Therefore, there is a need for a portable terminal that can display the captures images in normal direction without the need of a gravity sensor.

### SUMMARY OF THE INVENTION

An exemplary embodiment of the present invention is to provide an apparatus and method for extracting direction information of an image in a portable terminal, which can extract direction information of a captured image in the portable terminal without using a sensor.

According to an aspect of the present invention, an apparatus for extracting direction information of an image in a portable terminal includes: a camera unit for capturing the image; and a control unit for detecting a direction of an object from the captured image, storing the captured image with the detected direction of the object, and displaying the captured image in a normal direction by rotating the captured image responsive to the detected direction of the object.

According to another aspect of the present invention, a method for extracting direction information of an image in a portable terminal includes: detecting a direction of an object from an captured image, wherein the captured image is rotated by a predetermined orientation until the direction of the object is detected; and storing the captured image with the detected direction of the object as direction information for subsequently displaying the captured image in a normal direction.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram of a portable terminal according to an exemplary embodiment of the present invention;

FIGS. 2A and 2B are flow diagrams illustrating a process for extracting direction information of an image in a portable terminal according to an exemplary embodiment of the present invention;

FIGS. 3A to 3D are diagrams for describing a direction information extracting process in FIGS. 2A and 2B; and

FIGS. 4A to 4C are diagrams for describing object detection in FIGS. 2A and 2B.

### DETAILED DESCRIPTION OF THE INVENTION

Exemplary embodiments of the present invention will be described below in detail with reference to the accompanying drawings. Like reference numerals in the drawings denote like elements. The present invention may, however, be embodied in different forms and should not be construed as limited to the embodiments set forth herein; rather, these embodiments are provided so that this disclosure will be thorough and complete, and will fully convey the scope of the present invention to those skilled in the art.

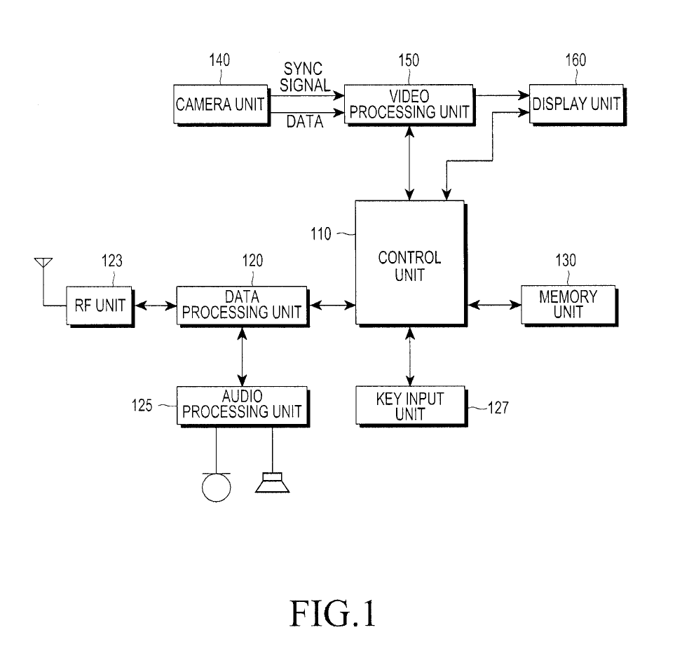

FIG. 1 is a block diagram of a portable terminal according to an exemplary embodiment of the present invention.

Referring to FIG. 1, a portable terminal according to an exemplary embodiment of the present invention includes a control unit 110, a data processing unit 120, a radio frequency (RF) unit 123, an audio processing unit 125, a key input unit 127, a memory unit 130, a camera unit 140, a video processing unit 150, and a display unit 160.

In operation, the RF unit 123 performs a wireless communication function of the portable terminal. The RF unit 123 includes an RF transmitter for upconverting and amplifying a transmission (TX) signal, and an RF receiver for low-noise-amplifying and downconverting a received (RX) signal. The data processing unit 120 includes a transmitter for encoding and modulating the TX signal, and a receiver for demodulating and decoding the RX signal. For example, the data processing unit 120 includes a modem and a codec. Herein, the codec includes a data codec for processing packet data, and an audio codec for processing audio signals (e.g., voice signals). The audio processing unit 125 processes an RX audio signal outputted from the audio codec of the data processing unit 120, and transmits a TX audio signal, generated by a microphone, to the audio codec of the data processing unit 120.

The key input unit 127 includes keys for inputting numeral and character information, and function keys for setting various functions.

The memory unit 130 may include a program memory and a data memory. The program memory may store programs for controlling a general operation of the portable terminal, and programs for extracting direction information of the portable terminal from a captured image through object detection.

Also, according to an exemplary embodiment, the memory unit 130 stores the captured image together with the direction information of the portable terminal extracted from the captured image through object detection.

The control unit 110 controls an overall operation of the portable terminal.

The control unit 110 displays a normal-direction image on the display unit 160 in a preview mode regardless of the position of the portable terminal (e.g., the position of the camera unit 140 of the portable terminal). However, when a photograph function is selected in the preview mode to store an image displayed on the display unit 160, the control unit 110 stores the captured image according to the photograph position of the camera unit 140. That is, the control unit 110 stores the captured image of the same subject in a different direction according to the photograph position of the camera unit 140.

According to an exemplary embodiment, when a photograph function is selected during an image display operation in the preview mode, the control unit 110 detects an object from an image, captured by the camera unit 140, through an object recognition function and extracts the object detection direction as direction information for displaying the image in the normal direction at an image viewer.

The direction of the captured image varies according to the position of the camera unit 140. Thus, if an object is not detected from the captured image through an object recognition function, the control unit 110 detects an object through the object recognition function by varying the direction of the captured image.

According to an exemplary embodiment, if the object is detected from the captured image, the control unit 110 extracts 0° direction information. If the object is detected from the image rotated by 90°, the control unit 110 extracts 90° direction information. If the object is detected from the image rotated by 180°, the control unit 110 extracts 180° direction information. If the object is detected from the image rotated by 270°, the control unit 110 extracts 270° direction information.

According to an exemplary embodiment, the control unit 110 controls the memory unit 130 to store the captured image together with the extracted direction information.

According to an exemplary embodiment, the control unit 110 stores the extracted direction information as image information such as EXIF (Exchangeable Image File Format) information.

If the object is a face, a character or an object, it may be detected through a face recognition function, a character recognition function or an object recognition function.

The face recognition function, the character recognition function, and the object recognition function are well known and thus their description will be omitted for conciseness.

The camera unit 140 includes a camera sensor for capturing video data and converting the video data into an electrical signal, and a signal processing unit for converting an analog video signal, captured by the camera sensor, into digital data. The camera sensor may include a CCD sensor or a CMOS sensor, and the signal processing unit may include a digital signal processor (DSP). Also, the camera sensor and the signal processing unit may be integrated into one unit, or may be separated from each other.

The video processing unit 150 performs an image signal processing (ISP) operation to display video signals, outputted from the camera unit 140, on the display unit 160. Examples of the ISP operation include gamma correction, interpolation, spatial change, image effects, image scaling, auto white balance (AWB), auto exposure (AE), and auto focus (AF). The video processing unit 150 processes the video signals, outputted from the camera unit 140, on a frame basis, and outputs the frame video data according to the size and characteristics of the display unit 160. Also, the video processing unit 150 includes a video codec to compress the frame video data displayed on the display unit 160 and restore the compressed frame video data into the original frame video data. The video codec may include a JPEG codec, an MPEG4 codec, or a Wavelet codec. The video processing unit 150 may have an on-screen display (OSD) function to output OSD data in accordance with a display screen size under the control of the control unit 110.

The display unit 160 displays the video signal outputted from the video processing unit 150, and displays the user data outputted from the control unit 110.

The display unit 160 may be implemented using an LCD. If the display unit 160 is implemented using an LCD, the display unit 160 may include an LCD panel, an LCD controller, and a memory for storing video data. The LCD may be a touchscreen LCD. If the LCD is a touchscreen LCD, it may also operate as an input unit. Also, the display unit 160 may display the keys of the key input unit 127.

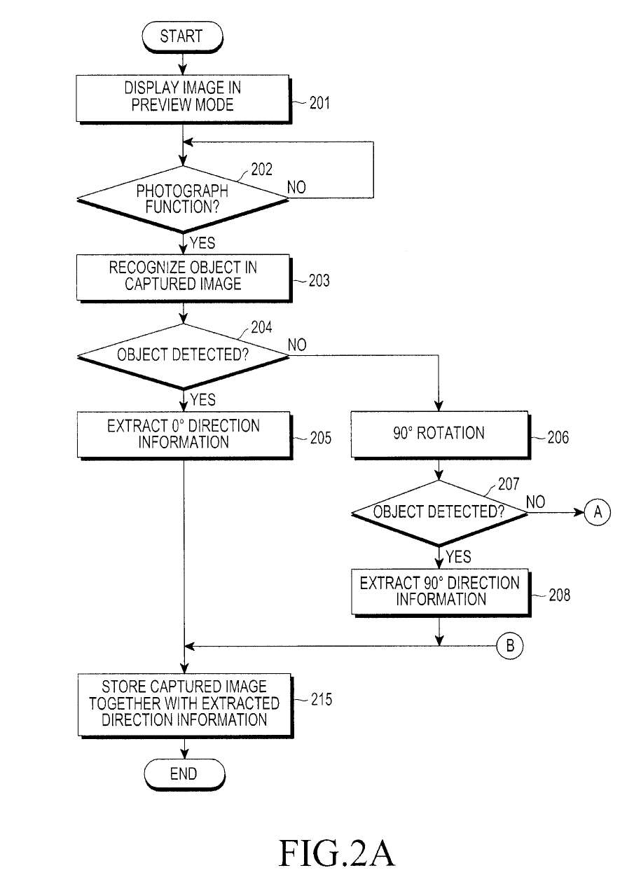

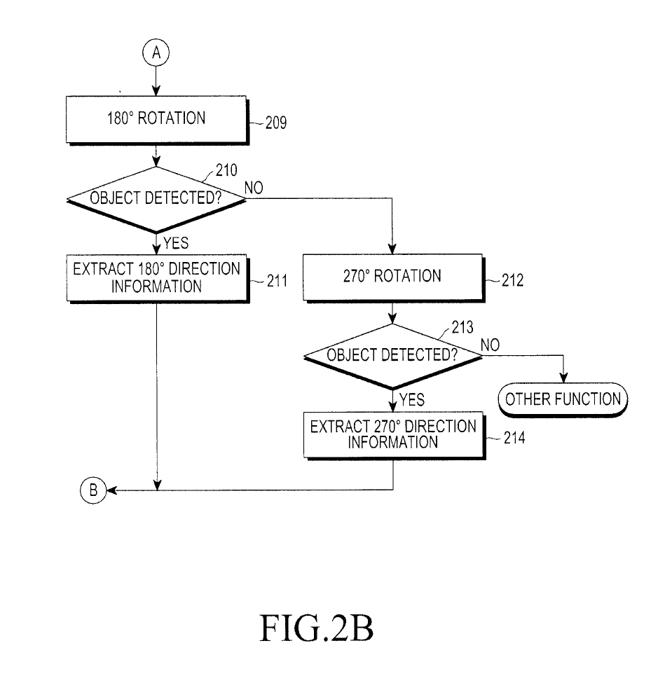

Hereinafter, a process for extracting direction information of an image in the portable terminal according to exemplary embodiments of the present invention will be described below in detail with reference to FIGS. 2 to 4.

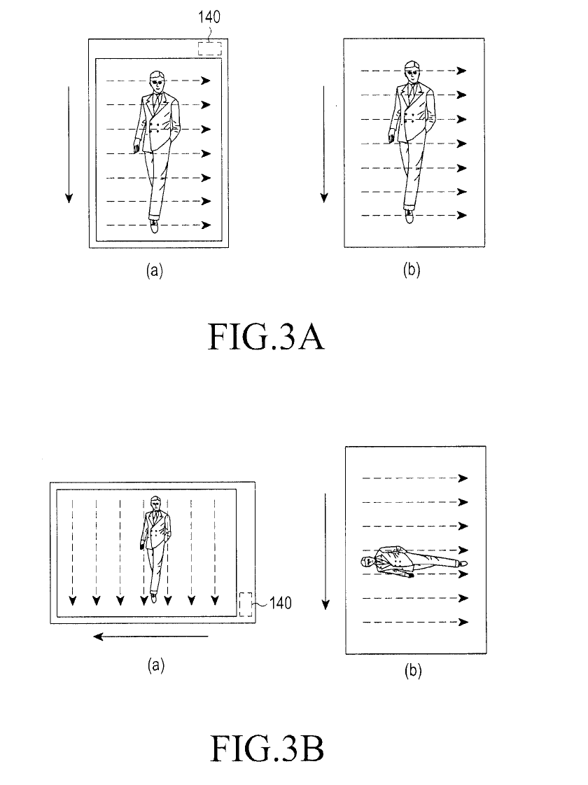

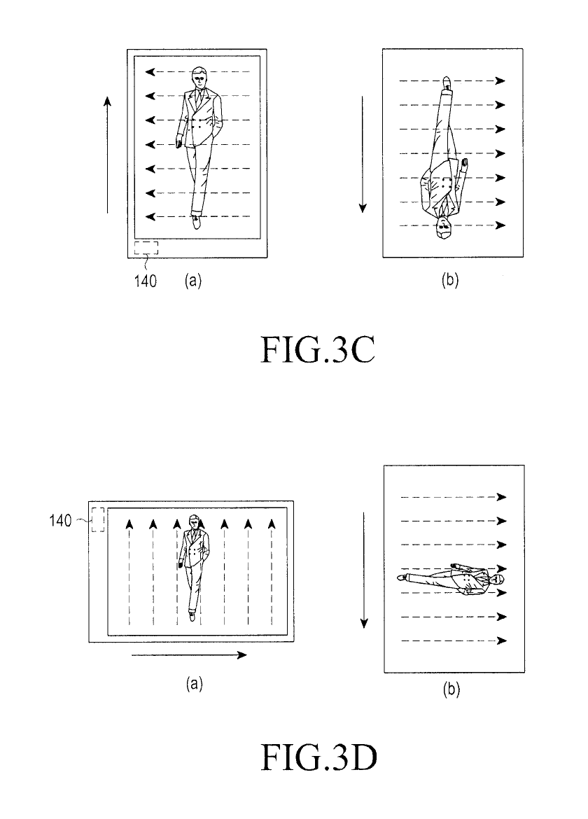

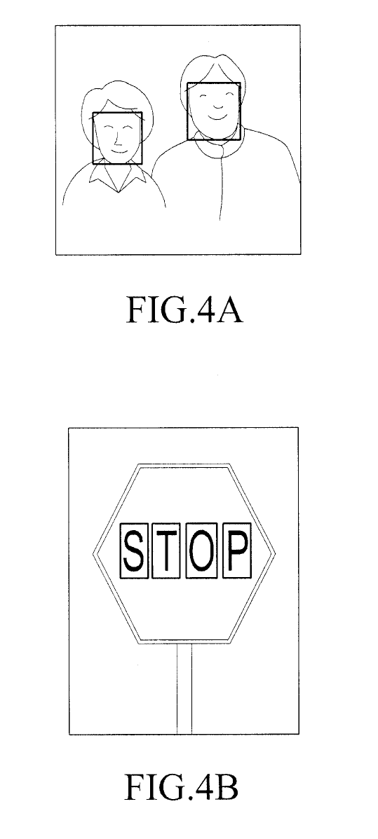

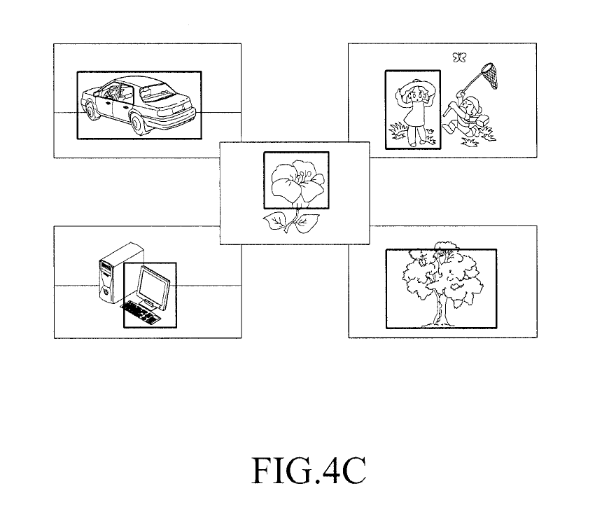

FIGS. 2A and 2B are flow diagrams illustrating a process for extracting direction information of an image in the portable terminal according to an exemplary embodiment of the present invention. FIGS. 3A to 3D are diagrams for describing the direction information extracting process in FIGS. 2A and 2B. FIGS. 4A to 4C are diagrams for describing the object detection in FIGS. 2A and 2B.

In an exemplary embodiment of the present invention, it is assumed that the direction information stored together with the captured image is any one of 0° direction information, 90° direction information, 180° direction information, and 270° direction information.

Referring to FIGS. 1, 2A and 2B, an image is displayed on the display unit 160 in a preview mode, in step 201. In step 202, the control unit 110 determines whether a photograph function is selected during the display of the image in the preview mode, and if so, the control unit 110 proceeds to step 203. In step 203, the control unit performs an object recognition function to detect an object from the captured image.

In step 204, the control unit 110 determines whether the object is detected from the captured image through the object recognition function, and if so, the control unit 110 proceeds to step 205. In step 205, the control unit 110 extracts 0° direction information as the direction information of the captured image.

As illustrated in of FIG. 3A(a), when a photograph function is selected in a preview mode through the camera unit 140 positioned in the 0° direction according to the position of the portable terminal, the video processing unit 150 reads image signals, outputted from the camera unit 140, as pixels of a captured image sequentially from left to right and from top to bottom. As illustrated in FIG. 3A(b), the video processing unit 150 outputs the read image pixels sequentially from left to right and from top to bottom, and the control unit 110 stores it as the captured image in the memory unit 130. The control unit 110 extracts a human face image from the captured image of FIG. 3A(b) through an object recognition function, and extracts 0° direction information as the direction information of the captured image. That is, if the control unit 110 recognizes a human face image from the captured image through the object recognition function, the control unit 110 recognizes the normal direction (i.e., 0°) thus not need to rotate the image, but if the human face is not recognized from the captured image, the control unit 110 rotates the image until the human face is recognized and extracts a rotated direction value to the direction information of the image.

Therefore, the controller unit detects that the direction information of the captured image through the object recognition function is 0°. For example the object recognition function of the present invention can recognize the human face from the captured image by previously storing the pixel value of the image which can recognize the objection, which is well-known to a person having an ordinary skill in the art.

On the other hand, if the object is not detected from the captured image through the object recognition function, the control unit 110 proceeds to step 206. In step 206, the control unit 110 rotates the captured image by 90° to detect the object through the object recognition function.

In step 207, the control unit 110 determines whether the object is detected from the 90°-rotated image through the object recognition function, and if so, the control unit 110 proceeds to step 208. In step 208, the control unit 110 extracts 90° direction information as the direction information of the captured image.

As illustrated in of FIG. 3B(a), when a photograph function is selected in a preview mode through the camera unit 140 positioned in the 90° direction according to the position change of the portable terminal, the video processing unit 150 reads image signals, outputted from the camera unit 140, as pixels of a captured image sequentially from top to bottom and from right to left. As illustrated in FIG. 3B(b), the video processing unit 150 outputs the read image pixels sequentially from left to right and from top to bottom, and the control unit 110 stores it as the captured image in the memory unit 130. Herein, a human face image is not detected through the object recognition function because a human face image is not displayed in the normal direction in the captured image of FIG. 3B(b). Thus, the control unit 110 rotates the image of FIG. 3B(b) by 90°, detects a human face image from the image of FIG. 3A(b), and extracts 90° direction information as the direction information of the captured image.

On the other hand, if the object is not detected from the 90°-rotated image through the object recognition function, the control unit 110 proceeds to step 209. In step 209, the control unit 110 rotates the captured image by 180° to detect the object through the object recognition function.

In step 210, the control unit 110 determines whether the object is detected from the 180°-rotated image through the object recognition function, and if so, the control unit 110 proceeds to step 211. In step 211, the control unit 110 extracts 180° direction information as the direction information of the captured image.

As illustrated in of FIG. 3C(a), when a photograph function is selected in a preview mode through the camera unit 140 positioned in the 180° direction according to the position change of the portable terminal, the video processing unit 150 reads image signals, outputted from the camera unit 140, as pixels of a captured image sequentially from right to left and from bottom to top. As illustrated in FIG. 3C(b), the video processing unit 150 outputs the read image pixels sequentially from left to right and from top to bottom, and the control unit 110 stores it as the captured image in the memory unit 130. Herein, a human face image is not detected through the object recognition function because a human face image is not displayed in the normal direction in the captured image of FIG. 3C(b). Thus, the control unit 110 rotates the image of FIG. 3C(b) by 180°, detects a human face image from the image of FIG. 3A(b), and extracts 180° direction information as the direction information of the captured image.

On the other hand, if the object is not detected from the 180°-rotated image through the object recognition function, the control unit 110 proceeds to step 212. In step 212, the control unit 110 rotates the captured image by 270° to detect the object through the object recognition function.

In step 213, the control unit 110 determines whether the object is detected from the 270°-rotated image through the object recognition function, and if so, the control unit 110 proceeds to step 214. In step 214, the control unit 110 extracts 270° direction information as the direction information of the captured image.

As illustrated in of FIG. 3D(a), when a photograph function is selected in a preview mode through the camera unit 140 positioned in the 270° direction according to the position change of the portable terminal, the video processing unit 150 reads image signals, outputted from the camera unit 140, as pixels of a captured image sequentially from bottom to top and from left to right. As illustrated in FIG. 3D(b), the video processing unit 150 outputs the read image pixels sequentially from left to right and from top to bottom, and the control unit 110 stores it as the captured image in the memory unit 130. Herein, a human face image is not detected through the object recognition function because a human face image is not displayed in the normal direction in the captured image of FIG. 3D(b). Thus, the control unit 110 rotates the image of FIG. 3D(b) by 270°, detects a human face image from the image of FIG. 3A(b), and extracts 270° direction information as the direction information of the captured image. In alternate embodiment, the rotation of image does not have to be performed in sequence as described above. Instead, the rotation of the image can be performed in any order of orientation.

When the direction information of the captured image is extracted through the object recognition function, the control unit 110 stores the captured image together with the extracted direction information, in step 215. That is, the present invention stores the direction information when storing the captured image. Namely, the captured image is not stored after rotating until the captured image is in 0° orientation, and the rotation is only for extracting the direction information. Therefore, the captured image is stored as it is, without the rotation, and stored with the extracted direction information, so the image is displayed by the normal direction through the stored direction information when displaying the stored image.

In the embodiment, the image is always displayed in the normal direction by rotating the image according to the extracted direction information when displaying the image through an image viewer. If the object detected from the captured image is a face, a character or an object, it may be detected through a face recognition function, a character recognition function or an object recognition function. For example, the character or the object can be recognized in the captured image by previously storing the pixel value of the image which can recognize the character or the object. This type of recognition is well-known in the art.

FIG. 4A illustrates the detection of a face object through a face recognition function. FIG. 4B illustrates the detection of a character object through a character recognition function. FIG. 4C illustrates the detection of an object through an object recognition function.

Although a description has been given of only an operation of extracting the direction information of the portable terminal in the process of storing the captured image, the present invention is also applicable to the case of video call and moving picture storage.

As described above, the present invention provides an apparatus and method for extracting direction information of an image in a portable terminal, thereby making it possible to extract direction information of a captured image in the portable terminal without using a sensor.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An apparatus for extracting direction information of an image in a portable terminal, comprising:
a camera unit for capturing an image; and
a control unit for extracting a detection direction of an object from the captured image as direction information for displaying the captured image in a normal direction, and storing the captured image together with the extracted direction information.

2. The apparatus of claim 1, wherein if the object is not detected from the image captured in a different direction according to a photograph position of the camera unit, the control unit changes the direction of the image and detects the object to extract the direction information.

3. The apparatus of claim 2, wherein the control unit extracts 0° direction information if the object is detected from the image; extracts 90° direction information if the object is detected from the 90°-rotated image; extracts 180° direction information if the object is detected from the 180°-rotated image; and extracts 270° direction information if the object is detected from the 270°-rotated image.

4. The apparatus of claim 1, wherein the object is at least one of a face, a character and an object.

5. A method for extracting direction information of an image in a portable terminal, comprising:
extracting a detection direction of an object from an captured image as direction information for displaying the captured image in a normal direction, when a storage function for the captured image is selected; and
storing the captured image together with the extracted direction information.

6. The method of claim 5, wherein the extracting of the detection direction of the object from the captured image as the direction information comprises:
detecting the object from the image captured in a different direction according to a photograph position of a camera unit;
extracting 0° direction information if the object is detected from the image; and
extracting the direction information by detecting the object by changing the direction of the image, if the object is not detected from the image.

7. The method of claim 6, wherein the extracting of the direction information comprises:
rotating the image by 90° to extract the direction information, if the object is not detected from the image;
extracting 90° as the direction information if the object is detected from the 90°-rotated image;
rotating the image by 180° to extract the direction information, if the object is not detected from the 90°-rotated image;
extracting 180° as the direction information if the object is detected from the 180°-rotated image;
rotating the image by 270° to extract the direction information, if the object is not detected from the 180°-rotated image; and
extracting 270° as the direction information if the object is detected from the 270°-rotated image.

8. The method of claim 5, wherein the object is at least one of a face, a character and an object.
